(19) United States
(12) Patent Application Publication
(10) Pub. No.: US 2004/0032131 A1
(43) Pub. Date: Feb. 19, 2004

(54) Electromechanical blind latch

(76) Inventor: Hitesh Cherry, Harrisburg, PA (US)

Correspondence Address: Paul & Paul, Suite 2900, Two Thousand Market Street, Philadelphia, PA, 19103, US

(21) Appl. No.: 10/414,144

(22) Filed: Apr. 14, 2003

Related U.S. Application Data
(60) Provisional application No. 60/372,645, filed on Apr. 14, 2002.

(51) Int. Cl. E05B 15/02

(52) U.S. Cl. 292/340

(57) ABSTRACT

The present invention is directed to an electromechanical blind latch having a catch with a hole that catches a groove of a keeper post.

### CROSS REFERRENCE TO RELATED APPLICATIONS

This application claims the benefit of the priority of U.S. Provisional Patent Application Serial No. 60/372,645, filed on Apr. 14, 2002. The entire disclosure of this application is incorporated herein by reference.

### BACKGROUND OF THE INVENTION

1. Field of the Invention

The present invention relates to an electromechanical blind latch.

2. Description of the Prior Art

Latches are used to releasably secure panels, covers, doors, electronic modules, and the like to other structures such as compartments, containers, door frames, other panels, frames, racks, etc. Although latches know as blind latches are known in the art, none offers the advantages of the present invention. The advantages of the present invention will be apparent from the attached description and drawings.

### SUMMARY OF THE INVENTION

The present invention is directed to an electromechanical blind latch.

### BRIEF DESCRIPTION OF THE DRAWINGS

FIG. 1 is a view of a cabinet with a blind latch according to the present invention installed therein.

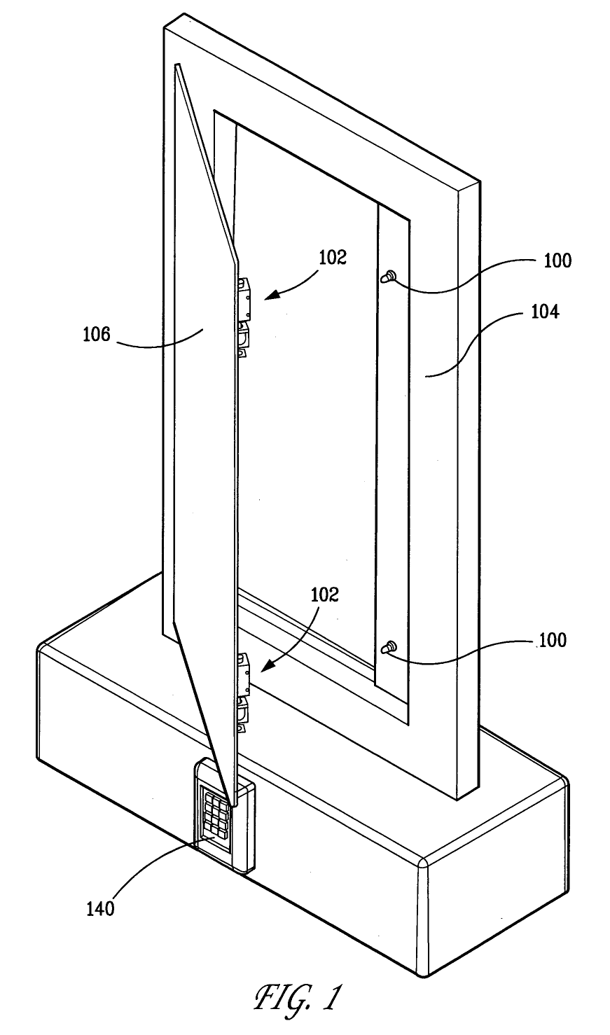

FIG. 2 is a perspective view of the catch assembly of the blind latch of the present invention.

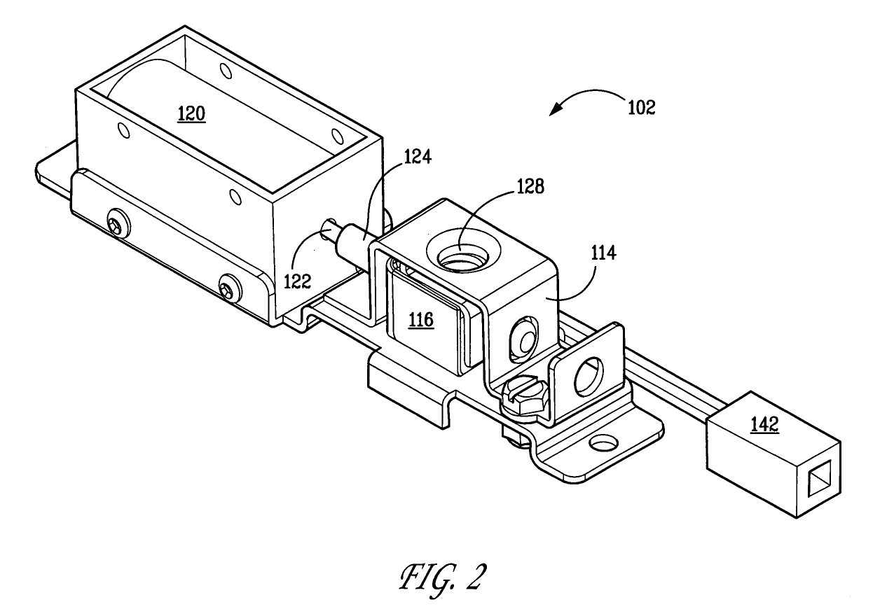

FIG. 3 is an exploded view of the catch assembly of the blind latch of the present invention.

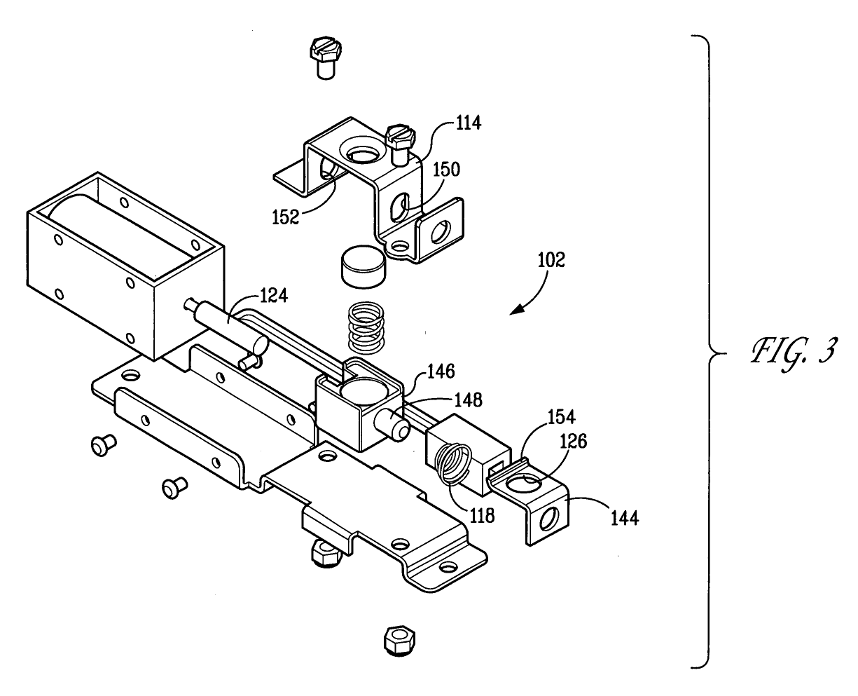

FIGS. 4-5 are views of the housing of the blind latch of the present invention.

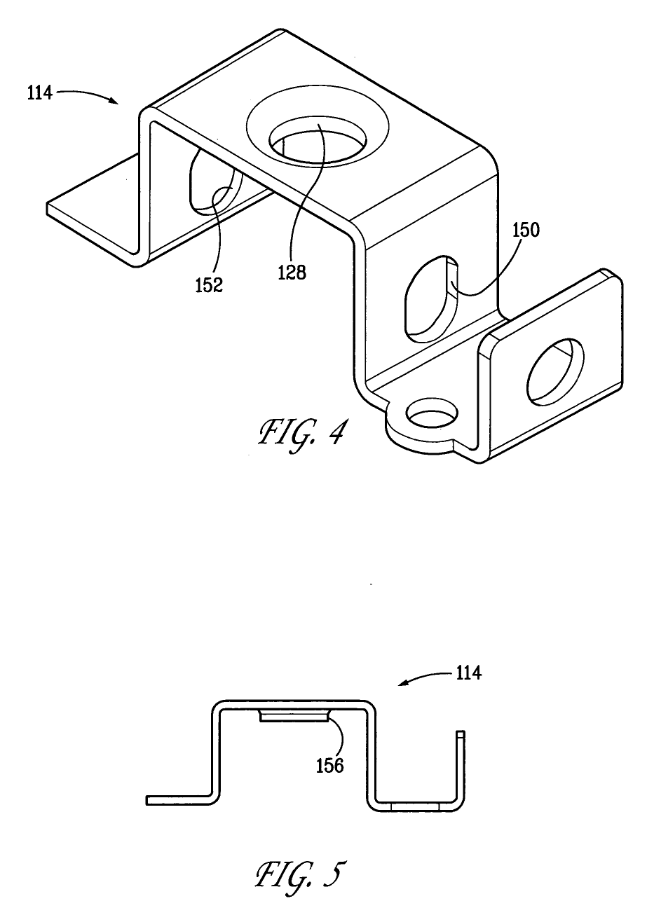

FIG. 6 is a cross sectional view of the catch assembly of the blind latch of the present invention installed to a door with the door open.

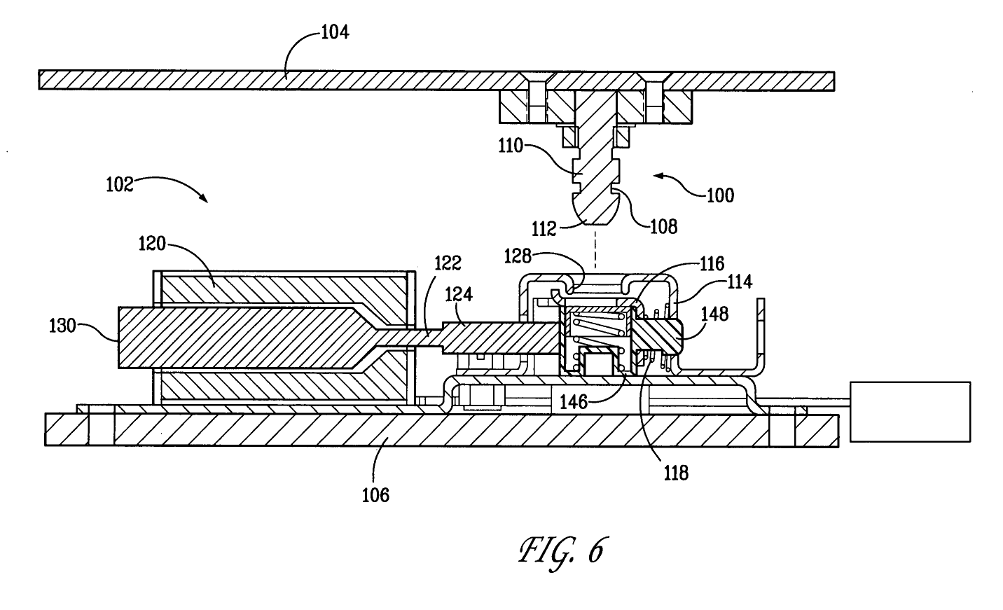

FIG. 7 is a cross sectional view of the catch assembly of the blind latch of the present invention installed to a door with the door partially closed.

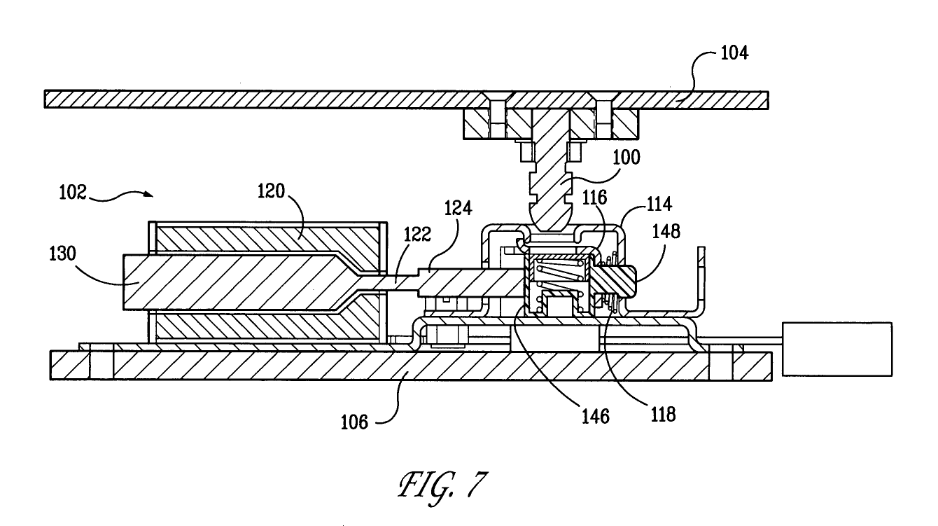

FIG. 8 is a cross sectional view of the catch assembly of the blind latch of the present invention installed to a door with the door fully closed.

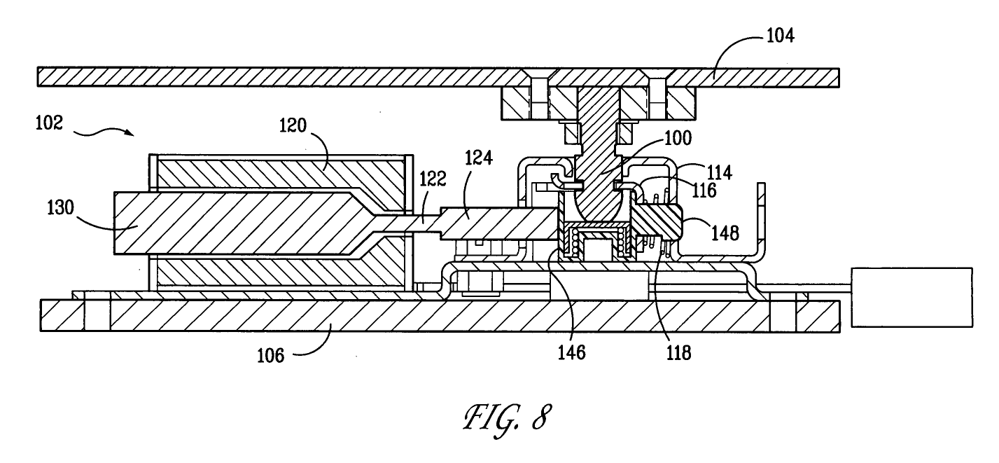

FIG. 9 is a view of a cabinet with a blind latch according to the present invention installed therein, with the catch assembly mounted to the door frame.

FIG. 10 is an exploded view of a second embodiment of the catch assembly of the blind latch of the present invention.

FIGS. 11-12 are views of the housing of a second embodiment of the blind latch of the present invention.

Similar reference characters denote corresponding features consistently throughout the attached drawings.

### DETAILED DESCRIPTION OF THE PREFERRED EMBODIMENTS

The present invention is directed to a blind latch comprising at least one keeper 100 and a catch assembly 102. The keeper 100 is usually mounted to the doorframe 104 and can be of the stationary or floating types. The keeper 100 is in the form of a post with at least one circular groove 108 around the shaft 110 and a head 112 that is convex and tapering in profile. The catch assembly 102 is mounted to the door 106. The catch assembly 102 includes a housing 114, a catch 116, a spring 118, a solenoid 120, and a solenoid plunger extension 124.

The catch 116 includes at least a plate-like portion with a hole 126 therein. The hole 126 is large enough to provide clearance for the passage of the keeper shaft 110 therethrough. The housing 114 also has a hole 128 that is large enough to provide clearance for the passage of the keeper shaft 110 therethrough. The catch 116 is slidably supported by the housing 114 and the catch 116 is movable between open and closed positions. The holes 126 and 128 are in concentric registry when the catch 116 is in the open position an allow ingress and egress of the keeper relative to the interior of the catch 116. In the closed position the periphery of the hole 126 engages the groove 108 to secure the keeper 100 to the catch assembly 102 and thus secure the door in the closed position.

The spring 118 biases the catch 116 toward the closed position. When the door 106 is initially slammed shut, with the solenoid 120 unenergized, The tapering end 112 of the keeper partially enters the hole 126 and pushes the catch 116 to the open position as the door is moved to the closed position. Once the door is in the closed position, the rim of the hole 126 is aligned with the groove 108 and a portion of the rim of the hole 126 can move into the groove 108 under spring force allowing the catch 116 to engage the keeper 100 and secure the keeper in place. The catch 116 is now in the closed position.

Opening the door is accomplished by energizing the solenoid 120. When the solenoid is energized the solenoid plunger 122 extends farther out of the solenoid housing and through the plunger extension 124 pushes the catch 116 to the open position against the force of spring 118, which allows the door to be opened while the solenoid is energized.

Compression force of the door gasket, if present, (or if door gasket is weak or not used, force of the internal spring) will spring open the door. In case of emergency, pushing on the solenoid plunger from non-engaged side 130 can unlatch door.

Solenoid has to be energized for unlocking for very short time. Energized time has to be minimized to prevent over-heating of the solenoid.

A numeric keypad 140 may used by a user to control energizing of the solenoids such that unauthorized access through the door is prevented.

A receptacle 142 is provided to make power and control connections to the catch assembly 102.

The catch 116 includes a plate-like portion or cover plate 144 and a box 146. The cover plate 144 carries the hole 126 that catches the keeper groove 108. The box 146 has a guide post 148 which fits through the hole 150 of the housing 114 to guide the sliding movement of the catch 116. The plunger extension 124 passes through the hole 152 of the housing 114 to engage and push on the catch 116. Also the plate portion 144 has a tab 154 that stops movement of the catch 116 at the end of its movement toward the open position by contacting the funnel extension surrounding and defining the opening 128.

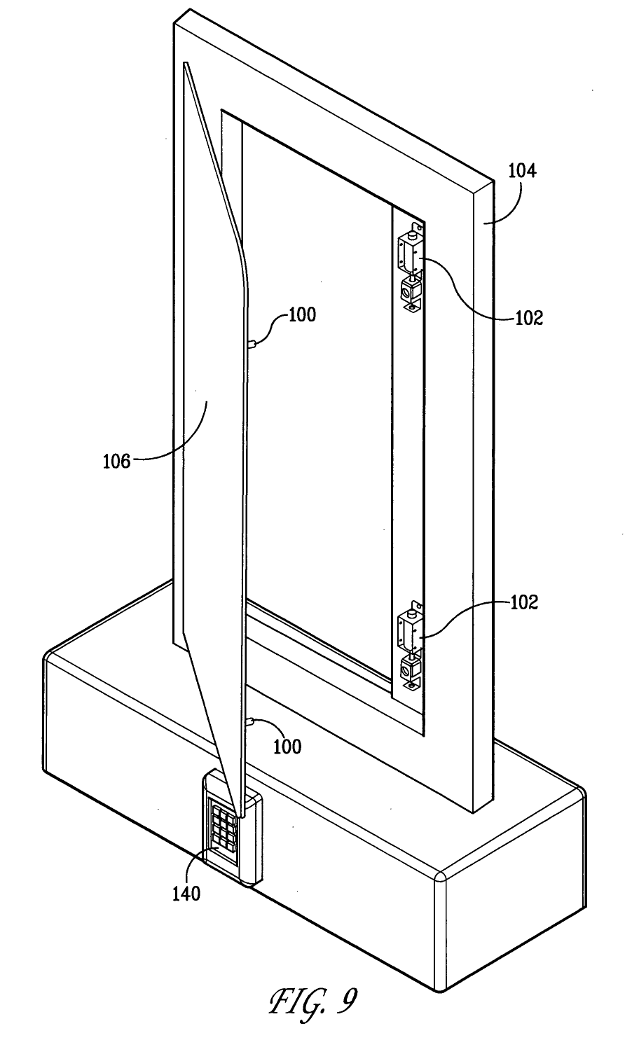

FIG. 9 shows the catch assemblies 102 mounted to the door frame 104 and the keeper posts 100 mounted to the door 106.

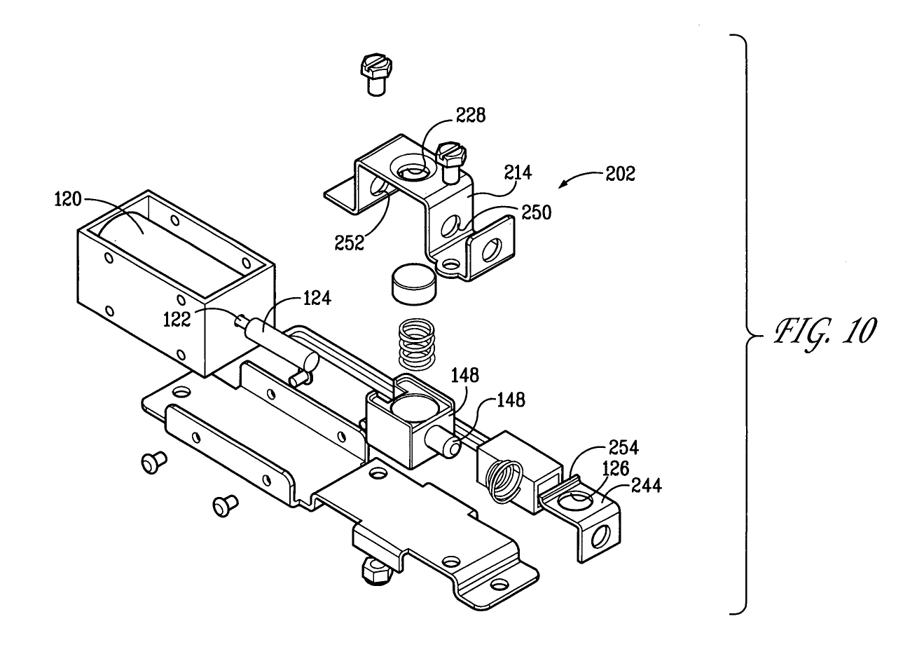

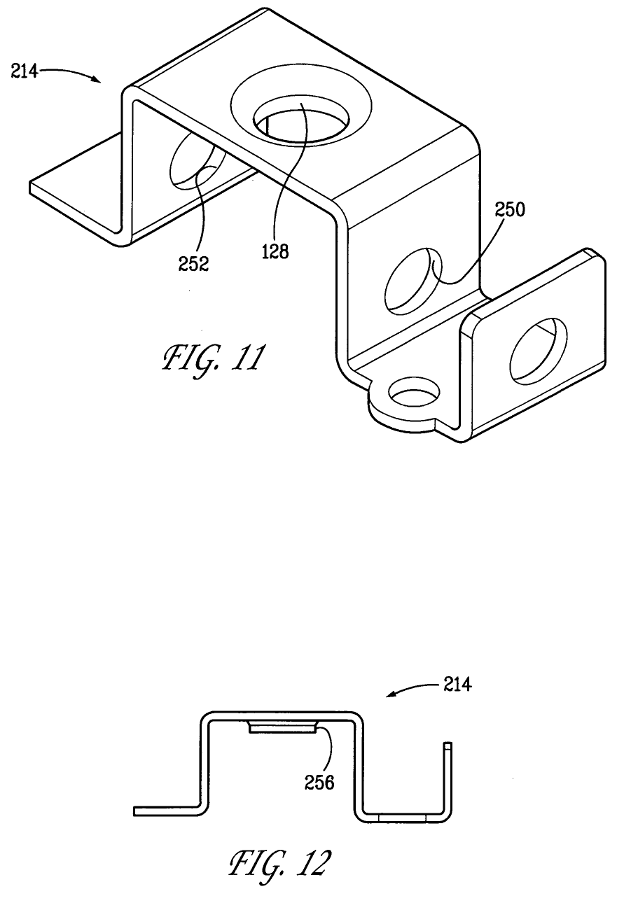

FIGS. 10-12 show a second embodiment of the catch assembly according to the invention. The catch assembly 202 is an earlier version of the catch assembly 102 and is identical to the catch assembly 102 except for the differences noted below. The holes 252 and 250 are circular whereas the holes 150 and 152 are oval. The oval holes provide a greater clearance for the deflection of the plunger extension 124 and the guide post 148 under the load applied by the keeper 100 when the door is being forced open without energizing the solenoid or a sealing gasket between the door and doorframe is being compressed. The excessive friction between the guide post 148 and the plunger extension 124 and the holes 150 and 252 can lead to the stalling of the solenoid. That is why the oval or slotted holes 150 and 152 have been adopted.

Other friction reducing measures include cutting back the funnel 256 to obtain the funnel 156, cutting back the tab 254 to obtain the tab 154, and lubricating the catch assembly 102. Also, low friction surface finishes and surface treatments may be applied to the catch assembly 102.

Examples of blind latches are disclosed in U.S. Pat. Nos. 4,597,599 and 6,149,213, the entire disclosures of which are incorporated herein by reference.

It is to be understood that the present invention is not limited to the embodiments disclosed above, but includes any and all embodiments within the scope of the appended claims.

1. An electromechanical blind latch system comprising:
a spring loaded catch having a hole and biased toward a closed position;
a solenoid acting on said spring loaded catch such that said solenoid moves said spring loaded catch to an open position when said solenoid is energized; and
a keeper in the form of a post having a groove,
wherein an edge defined by said hole catches said groove to retain said keeper in a closed position relative to said spring loaded catch, and said keeper is releases when said solenoid is energized.
